(19) United States
(12) Patent Application Publication
(10) Pub. No.: US 2013/0125933 A1
(43) Pub. Date: May 23, 2013

(54) QUICK DISCONNECT POWER AND PUMP SYSTEM FOR MANUAL PARTS WASHERS

(71) Applicant: ROBERT BROWN, III, Irwindale, CA (US)

(72) Inventor: ROBERT BROWN, III, Irwindale, CA (US)

(21) Appl. No.: 13/303,142

(22) Filed: Nov. 23, 2011

(51) Int. Cl. B08B 3/04; F16K 49/00; F16L 3/00

(52) U.S. Cl. 134/105; 137/343; 137/334

(57) ABSTRACT

A Quick Disconnect Power and Pump System for Manual Parts Washers includes a Housing Base, a Pump Tube, and a Thermowell. This Quick Disconnect Power and Pump System for Manual Parts Washers is used for the purpose of connecting a plurality of conduits and for housing objects.

### FIELD OF THE INVENTION

The present invention is in the area of cleaning systems and more particularly pertains to a Quick Disconnect Power and Pump System for Manual Parts Washers for connecting a plurality of conduits and for housing various cleaning devices.

### BACKGROUND

There are many types of machine parts that cannot simply be washed and cleaned through use of regular soap and water. Some mechanical parts, due to their extended exposure to various oils, chemicals, or other solvents must be treated with very powerful cleaning tools. Oftentimes, these mechanical parts are cleaned through highly specialized equipment with increased water pressure, heated water, solvents, and other equipment.

During the parts cleaning process, the cleaning fluids or solvents used with the parts washers must be replaced periodically. In order to replace these cleaning fluids or solvents, the sink and the connecting apparatus must be removed from the drum portion of the machine. This process can be time consuming and cumbersome. Furthermore, this process can present some dangers often associated with lifting heavy objects.

### SUMMARY

In general, in a first aspect, the Invention Title features Quick Disconnect Power and Pump System for Manual Parts Washers 100 includes a Base, a Pump Tube, and a Thermowell for housing the capillary tube of the Thermostat. The Apparatus enables a user to quickly remove several hoses, electrical equipment, a heater, etc., by providing a lightweight unit that can secure all of the same in one unit.

In addition, this apparatus has a mounting plate with an orifice with which it may hang on a parts washer, sink, or basin. This unit can then be quickly and easily removed to enable a user to begin working on another task related to the cleaning of various mechanical parts or the service of other parts washer machines.

The features and advantages described in this summary and the following detailed description are not all-inclusive. Many additional features and advantages will be apparent to one of ordinary skill in the art in view of the drawings, specification, and claims thereof.

### BRIEF DESCRIPTION OF THE DRAWING FIGURES

FIG. 1 is a front elevation view of an embodiment.

FIG. 2 is a rear elevation view of an embodiment.

FIG. 3 is a plan view of an embodiment.

FIG. 4 is a side elevation view of an embodiment.

FIG. 5 is a side elevation view of an embodiment.

FIG. 6 is a plan view of an embodiment.

FIG. 7 is a perspective view of an embodiment.

FIG. 8 is a perspective view of an embodiment.

FIG. 9 is a front elevation view of an embodiment.

FIG. 10a is a front elevation view of an embodiment.

FIG. 10b is a front elevation view of an embodiment.

FIG. 11 is a perspective view of an embodiment.

FIG. 12 is a perspective view of an embodiment.

FIG. 13 is a perspective view of an embodiment.

FIG. 14 is a perspective view of an embodiment.

FIG. 15 is a perspective view of an embodiment.

FIG. 16 is a perspective view of an embodiment.

FIG. 17 is a perspective view of an embodiment.

### DETAILED DESCRIPTION

According to an embodiment a Quick Disconnect Power and Pump System for Manual Parts Washers is provided for the purpose of connecting a plurality of conduits and housing objects.

The Quick Disconnect Power and Pump System for Manual Parts Washers is designed to facilitate the process of disconnecting the connecting apparatus from the sink and the drum portion of the parts washer. In turn, users can save man-hours, and gain attendant cost-savings from the accrual of the reduced process time. Moreover, users may save money as a result of safer working conditions due to the lighter lifting during the disconnection process.

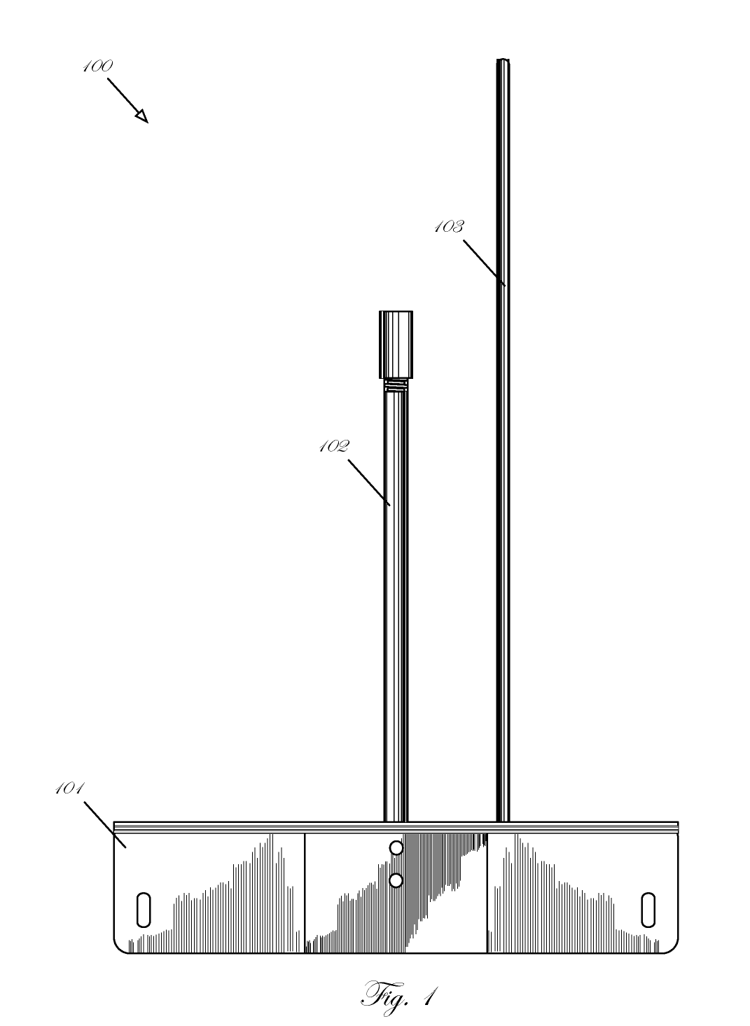

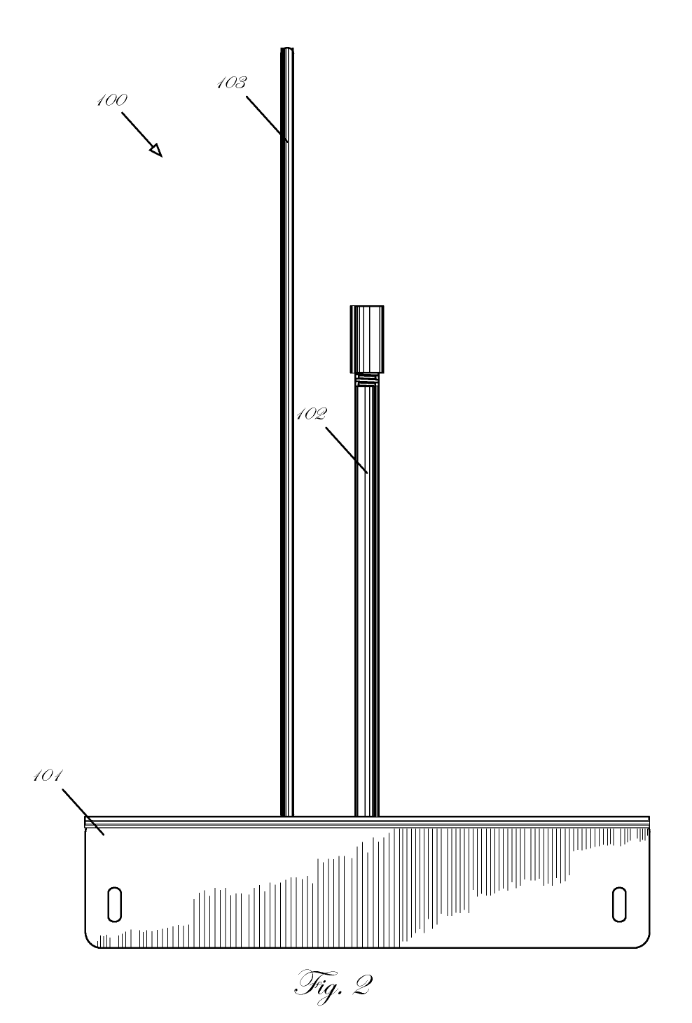

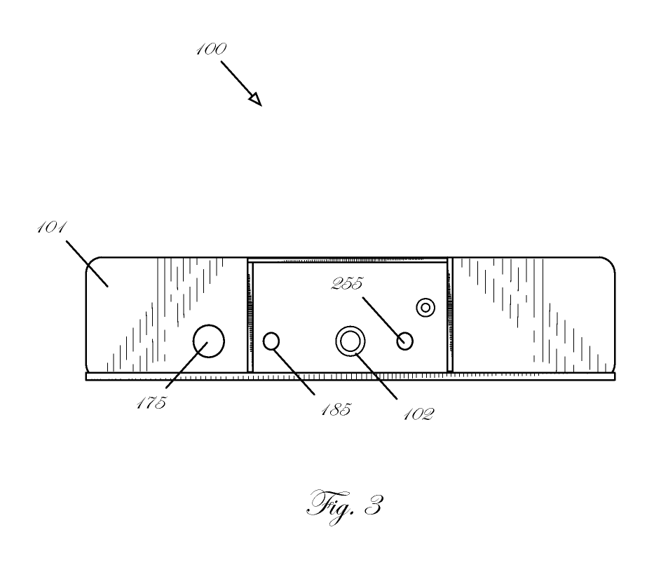

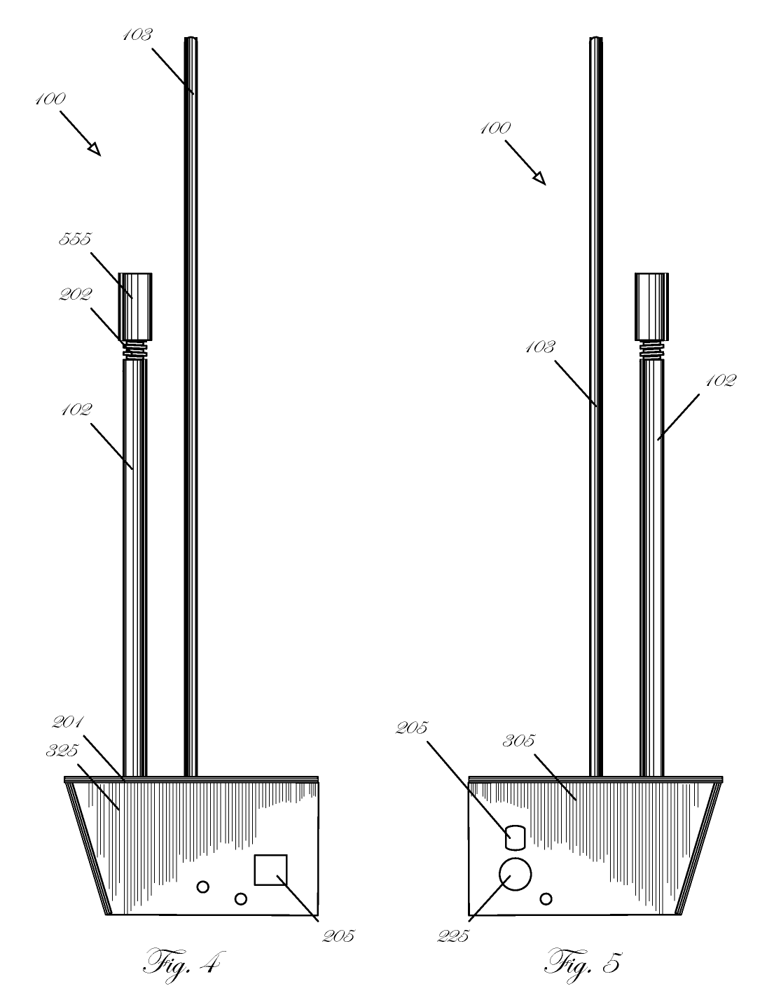

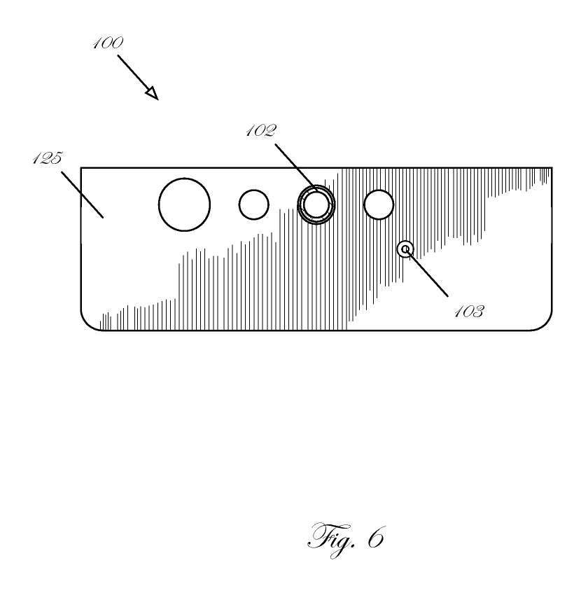

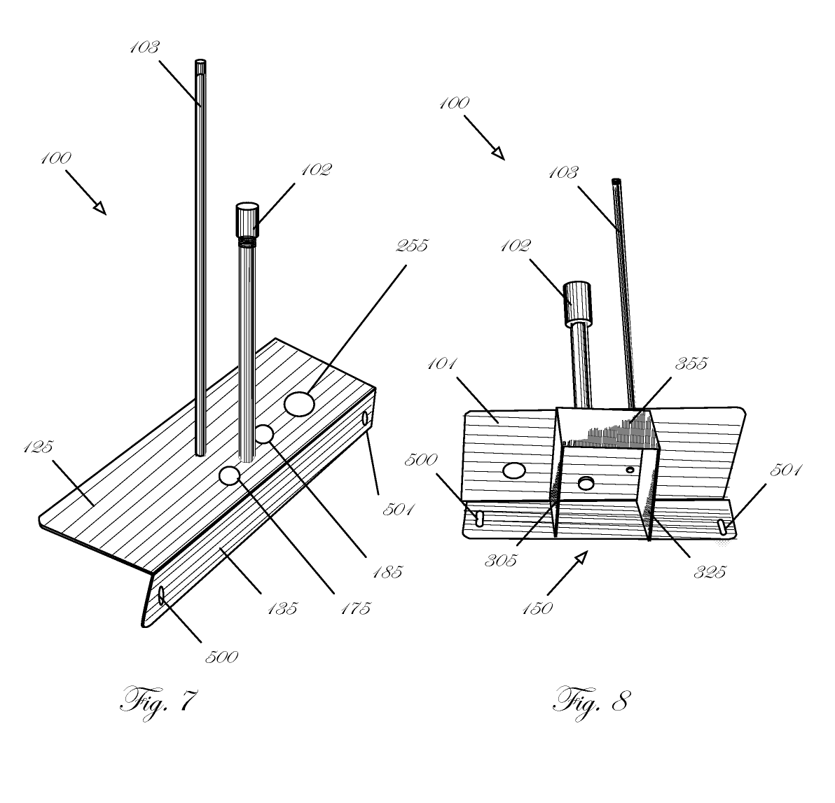

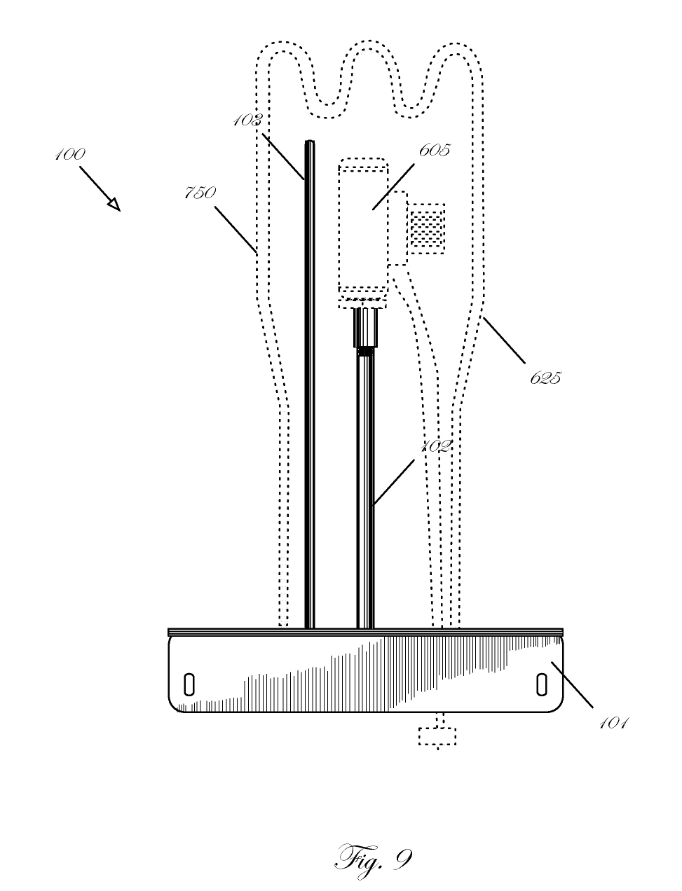

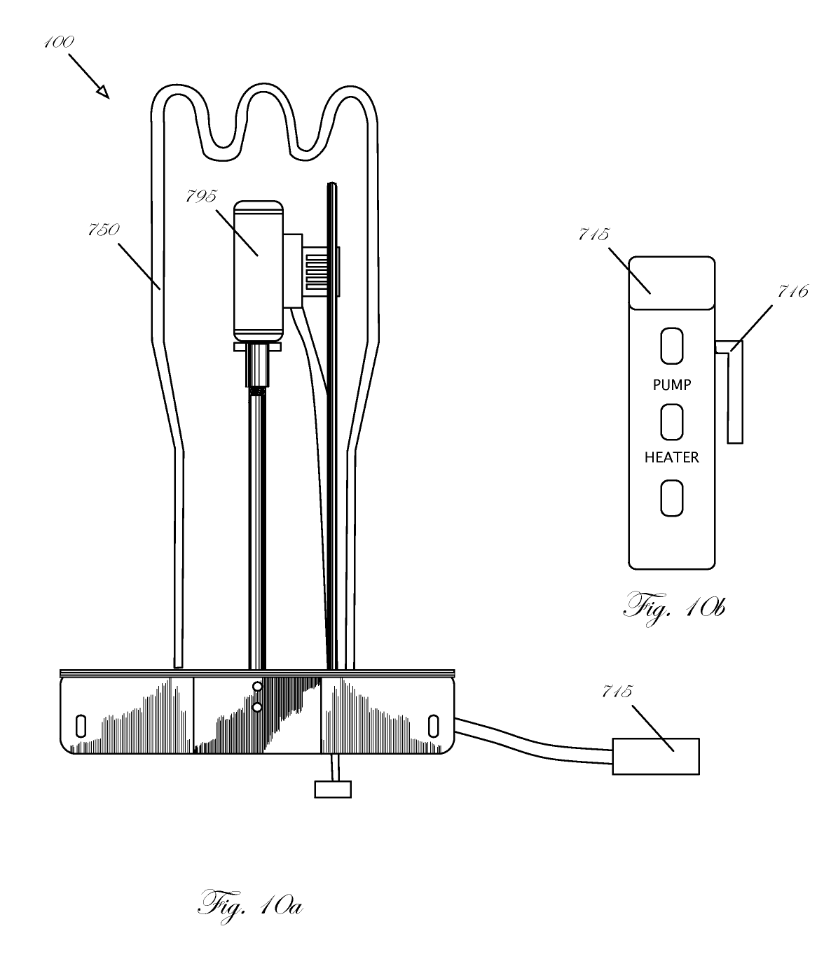

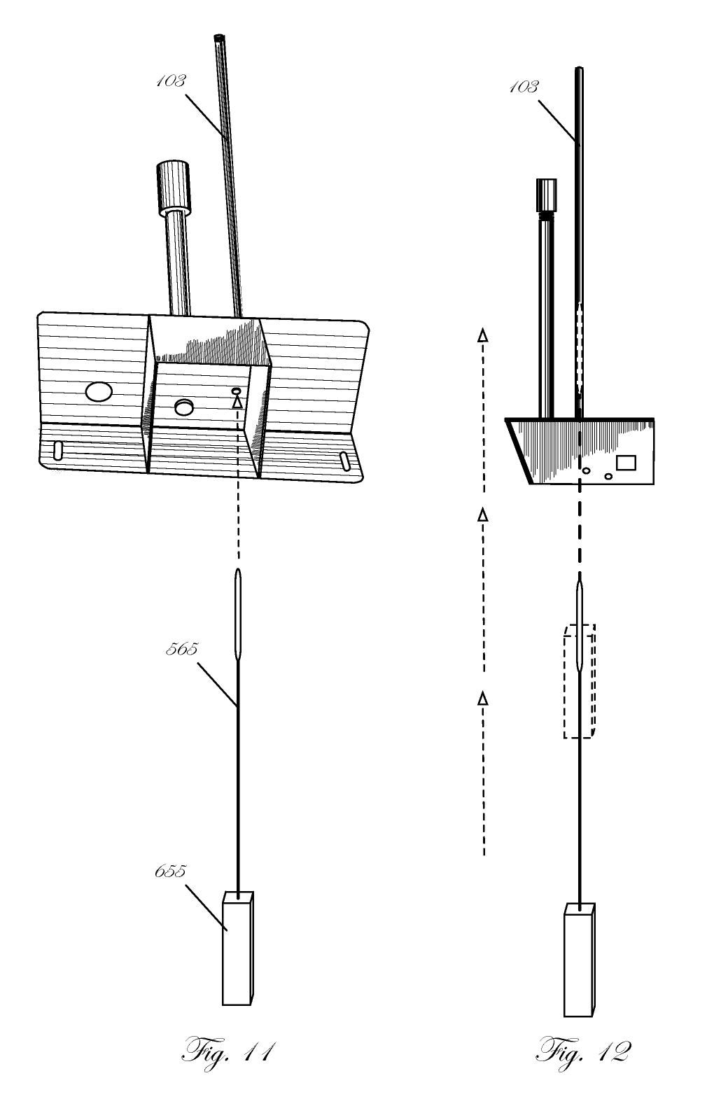

FIG. 1 illustrates that the Quick Disconnect Power and Pump System for Manual Parts Washers 100 includes a Housing Base 101, a Pump Tube 102, a Thermowell 103 for housing the capillary tube of the Thermostat. The Apparatus enables a user to quickly remove several hoses, electrical equipment, a heater, etc., by providing a lightweight unit that can secure all of the same in one unit.

In addition, as illustrated in FIG. 7, this apparatus has a mounting plate 135 with an orifice 500 with which it may hang on a parts washer, sink, or basin. This unit can then be quickly and easily removed to enable a user to begin working on another task related to the cleaning of various mechanical parts or the service of other parts washer machines.

The Housing Base 101 is used for the purpose of connecting a plurality of objects. For instance, the Housing base can be used to connect several rubber hoses that are used to transfer a flow of fluids. It can also have a plurality of outlets and orifices sized to accept various electrical cords. The Housing Base is disposed underneath the pump tube, heater, and Thermowell. The Housing Base, in one embodiment includes a Top Plate 125, a Mounting Plate 135, and a Control Housing 150 as illustrated in FIGS. 7-8 and in FIG. 18.

FIG. 7 illustrates through a plan view of one embodiment that the Top Plate is a planar member. And the Top Plate is affixed to the control housing. In addition, the Top Plate is a metal plate.

FIG. 3 illustrates that in one embodiment, the Top Plate may include a first hose orifice 175, a second hose orifice 255 and a third hose orifice 185. In one embodiment, the first hose orifice can be used to accept a hose that is in communication with a pump. The second and third hose orifices, in one embodiment may be used to accept a hose that is in communication with a heater. In one particular embodiment, the Quick Disconnect Power and Pump System may include a pump 795 for the purpose of pumping fluids.

Gaskets may also be used to completely seal the hoses. Note that in one embodiment, the top plate and mounting plate may be formed through one sheet of metal bent at an angle. In other embodiments, the top plate and the mounting plate may be two separate plates affixed to each other.

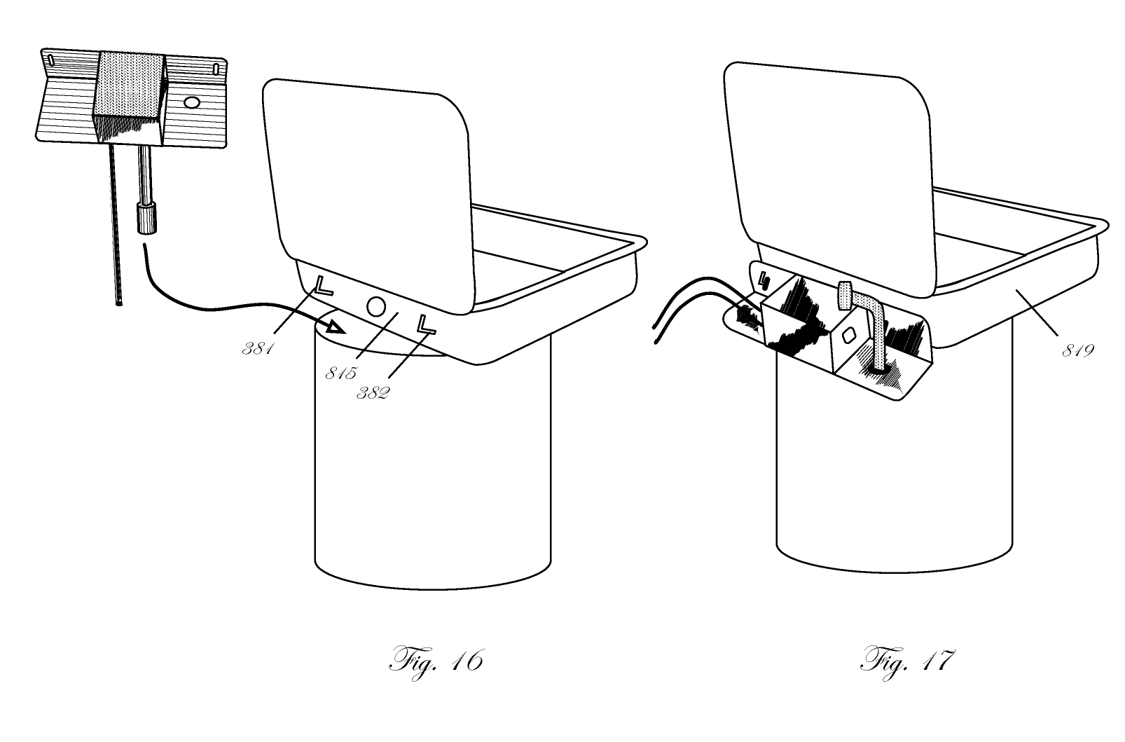

Also, the Mounting Plate is an elongate planar member. And the Mounting Plate abuts the Top Plate. In addition, the Mounting Plate is a metal plate with at least one orifice 500, 501. FIGS. 16-17 illustrate in one embodiment that the orifice is used for the purpose of hanging the apparatus upon a hook 381, 382, mounting bracket or other suitable structure. This hook may be found on a parts washer, sink, or a basin.

FIG. 8 illustrates in one embodiment that the Control Housing is disposed underneath the Top Plate. The Control Housing may be used to house various electrical units such as a heater, pump, or other related device or apparatus. These parts may be dangerous if placed into contact with water. As such, the walls of the Control Housing may have to be sealed with well-known tools in the art.

FIG. 8 illustrates in one embodiment that the Control Housing may comprise a rear plate 355, a first side plate 325, a cover plate 356 (illustrated in FIG. 18) and a second side plate 305 as illustrated in FIG. 8. The first side plate may include a square orifice 205 for the purpose of allowing an electrical plug to fit inside. In one embodiment, this orifice is sized to fit a 110 Volt plug. The second side plate 305 may include a circular orifice 225 and an elliptical orifice 205.

FIGS. 10a-10b illustrate in one embodiment, that the Quick Disconnect Power and Pump System for Manual Parts Washers may also include an actuator 715. The actuator is used for the purpose of actuating the pump, heater, or other process tied to the parts washer. In one embodiment, the actuator is in communication with the control housing which houses the device.

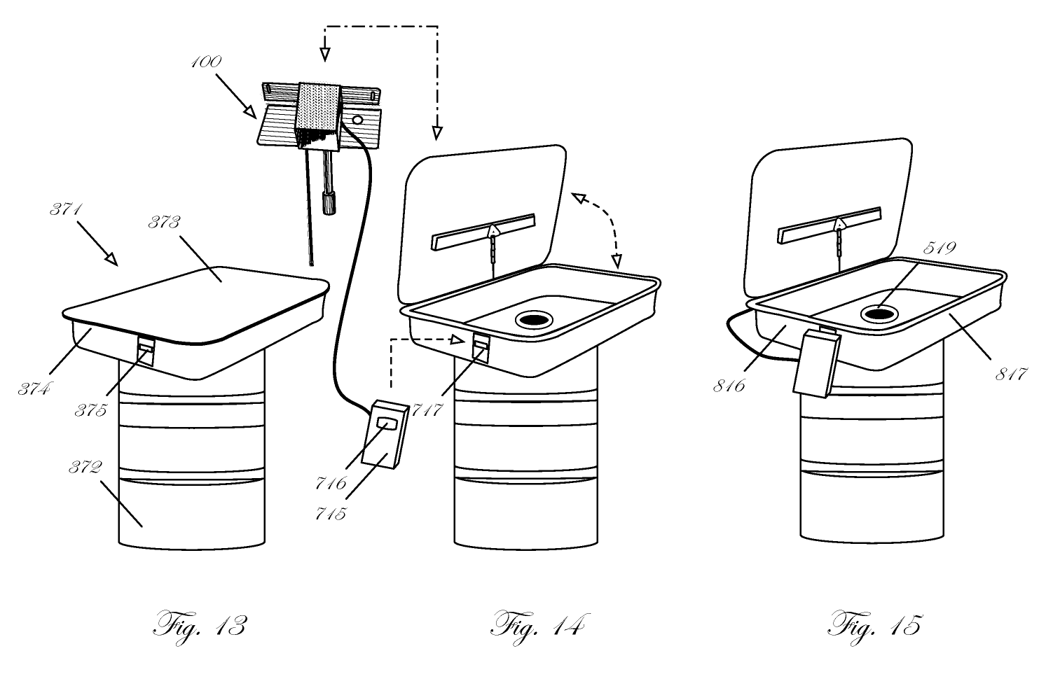

FIG. 10b illustrates in one embodiment that the actuator may further comprise a clip 716. The clip is used to releasably couple the actuator to the side of the parts washer as illustrated in FIGS. 13-15. The clip engages with a cooperating receiving structure 717 to retain the actuator in place.

The Pump Tube 102 is used for the purpose of retaining a pump 795. In one embodiment, the Pump Tube 102 is cylindrical. Also, the Pump Tube is disposed on the Top Plate. Moreover, in various implementations of an embodiment, the Pump Tube can be a pipe. The Pump Tube, in one embodiment includes a First Distal End 201, and a Second Distal End 202 as illustrated in FIG. 4. The Second Distal End may be internally or externally threaded to engage with a complementarily threaded pipe, hose, or other conduit. In addition, one embodiment may further include an adapter unit 555 to be affixed to the Second Distal End. This adapter unit may be used to engage with the pump. In one embodiment, the Quick Disconnect Power and Pump System for Manual Parts Washers may also include a pump 795 for the purpose of pumping fluids.

FIGS. 11-12 illustrate in one embodiment, that the Thermowell is used for the purpose of housing the Thermostat Capillary Tube 565. The thermostat capillary tube, in turn, is in communication with the thermostat 655. In one embodiment, the thermowell is closed off on the top end.

The Thermowell protects the Thermostat's capillary tube from water or other solvents, which may affect the copper from which the capillary tube is constructed. In one embodiment, the Thermowell is cylindrical. Also, the Thermowell is connected to the Top Plate. Moreover, in various implementations of an embodiment, the Thermowell and Capillary Tube can be a thin tube. In one particular embodiment, the Quick Disconnect Power and Pump System for Manual Parts Washers may also incorporate a Thermostat for the purpose of regulating the temperature of the fluids.

FIGS. 9, 10a-10b illustrate how the apparatus can be used in conjunction with various pumps, conduits, hoses, and coils. In one embodiment, the apparatus will allow a heater coil of the heater to pass through the top plate on one side, and exit through the opposite side.

A pump 795 is engaged with the pump tube securely. In one embodiment, the Quick Disconnect Power and Pump System for Manual Parts Washers may further include a heater 750, and a pump assembly 605. The heater is a serpentine conduit which engages on one side of the top plate and extends to the opposite side of the top plate.

FIGS. 13-17 illustrate that a Parts Washer with a Quick Disconnect Power and Pump System for Manual Parts Washers 371 includes a hood 373, a basin 374, a barrel 372 for housing the water, fluids, or solvents 372, a receiving clip 717 for releasably engaging with the actuator clip 716 disposed upon the actuator of the Quick Disconnect Power and Pump System for Manual Parts Washers 100, and a pair of hooks or mounting bracket is disposed on the rear side of the basin 815.

The Parts Washer is disposed on top of the barrel. As illustrated in FIG. 15, the basin is comprised of a front side 817, a first side 816, a second side 819, a drainage orifice 519 and a rear side 815. The hood is pivotally hinged with the basin.

FIGS. 16-17 illustrate that in operation, the Quick Disconnect Power and Pump System for Manual Parts Washers is inserted into the barrel upside down such that the orifices on the mounting plate are hung on top of the hooks which are mounted on the rear side of the basin.

It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. An Apparatus comprising:
a Housing Base, a Pump Tube, a Thermowell;
the Housing Base is disposed underneath the pump tube and capillary tube;
the Pump Tube is disposed on the Top Plate;
the Thermowell is in communication with the Top Plate.

2. The Apparatus of claim 1 wherein the Housing Base comprises a Top Plate, a Mounting Plate, and a Control Housing;
the Pump Tube comprises a First Distal End, and a Second Distal End.

3. The Apparatus of claim 1 wherein the system further includes a manual parts washer.

4. The Apparatus of claim 2 wherein the control housing having a rear plate, a first side plate, a cover plate and a second side plate;
the first side plate having a square orifice for the purpose of allowing an electrical plug to fit inside;
the square orifice is sized to fit a 110 Volt plug;
the second side plate having a circular orifice and an elliptical orifice.

5. The Apparatus of claim 1 further comprising an actuator;
the actuator is used for the purpose of actuating a pump or a heater;
the actuator is in communication with the control housing which houses the device;
the actuator comprises a clip.

6. The Apparatus of claim 2 wherein the Top Plate is a planar member;
the control housing is affixed to the top plate;
the Top Plate is a metal plate;
the Mounting Plate is an elongate planar member;
the Mounting Plate abuts the Top Plate;
the Mounting Plate is a metal plate with at least one orifice;
the Control Housing is disposed underneath the Top Plate.

7. An Apparatus comprising:
a Housing Base for the purpose of connecting a plurality of objects, a Pump Tube for the purpose of engaging a pump and liquid conduit, a heater for the purpose of heating fluids, a pump for the purpose of pumping fluids, a Thermowell for protecting a capillary tube;
the Housing Base comprises a Top Plate, a Mounting Plate, and a Control Housing;
the Top Plate is a planar member;
the control housing is affixed to the top plate;
the Top Plate is a metal plate;
the Mounting Plate is an elongate planar member;
the Mounting Plate abuts the Top Plate;
the Mounting Plate is a metal plate with at least one orifice;
the Pump Tube comprises a First Distal End, and a Second Distal End;
whereby the Quick Disconnect Power and Pump System for Manual Parts Washers provides an apparatus for quick disassembly from a parts washer thereby relieving unnecessary manual labor.

8. The Apparatus of claim 7 further comprising an actuator having a clip to releasably engage with a parts washer and for the purpose of actuating a pump or a heater.

9. The Apparatus of claim 7 wherein the mounting plate comprises at least two oval orifices for the purpose of releasably engaging with a plurality of hooks on a parts washer.

10. Apparatus of claim 7 further comprising a heater; the heater is a serpentine member.

11. The Apparatus of claim 8 wherein the actuator comprises a clip; the clip is releasably engaged with a parts washer.

12. The Apparatus of claim 7 further comprising a manual parts washer.

13. The Apparatus of claim 7 wherein the Thermowell houses a capillary tube which is in communication with a Thermostat.

14. The Apparatus of claim 13 further comprising a pump; the pump is in communication with the pump tube.

15. A Manual Parts Washer and a Quick Disconnect Power and Pump System comprising:
a Parts Washer and a Quick Disconnect Power and Pump System for Manual Parts Washers;
the parts washer is comprised of a hood, a basin having a receiving clip, and a barrel for the purpose of housing fluids;
the basin is comprised of a drainage orifice, a front side, a first side, a second side, and a rear side;
the parts washer is disposed on top of the barrel;
the barrel is a cylindrical member;
the hood is pivotally hinged with the basin;
the Quick Disconnect Power and Pump System for Manual Parts Washers comprises a Housing Base for the purpose of connecting a plurality of objects, a Pump Tube for the purpose of engaging with a pump and fluid conduit, a Thermowell for the purpose of housing a capillary tube, a thermostat for regulating the temperature of the fluids, a pump, and an actuator for actuating the pump and a heater;
the Housing Base is disposed underneath the pump tube and thermowell;
the Pump Tube is disposed on a Top Plate of the housing base;
the Thermowell is in communication with the Top Plate;
whereby the Manual Parts Washer and Quick Disconnect Power and Pump System enables a user to quickly and easily remove dirty solvents, fluids, and the like which were contaminated from various mechanical parts which were washed in the basin of the parts washer.

16. The Manual Parts Washer with a Quick Disconnect Power and Pump System for Manual Parts Washers of claim 15 wherein the heater is a serpentine member in communication with the top plate of the housing base.

17. The Manual Parts Washer with a Quick Disconnect Power and Pump System for Manual Parts Washers of claim 15 wherein the Top Plate is a planar member;
the control housing is affixed to the top plate;
the Top Plate is a metal plate;
the Mounting Plate is an elongate planar member;
the Mounting Plate abuts the Top Plate;
the Mounting Plate is a metal plate with at least one orifice.

18. The Manual Parts Washer with a Quick Disconnect Power and Pump System for Manual Parts Washers of claim 15 wherein the housing base further comprises a Control Housing; the Control Housing comprises a rear plate, a first side plate, a cover plate, and a second side plate;
the first side plate having a square orifice for the purpose of allowing an electrical plug to fit inside;
the square orifice is sized to fit a 110 Volt plug;
the second side plate having a circular orifice and an elliptical orifice.

19. The Manual Parts Washer with a Quick Disconnect Power and Pump System for Manual Parts Washers of claim 15 wherein the housing base further comprises a mounting plate with an orifice for the purpose of hanging the Quick Disconnect Power and Pump System for Manual Parts Washers on the parts washer.

20. The Manual Parts Washer with a Quick Disconnect Power and Pump System for Manual Parts Washers of claim 15 wherein the Top Plate comprises a first hose orifice, a second hose orifice and a third hose orifice;
the first hose orifice sized to accept a hose in communication with the pump;
the second and third hose orifices are sized to accept a hose in communication with the heater.
